(19) United States
(12) Patent Application Publication
(10) Pub. No.: US 2014/0338524 A1
(43) Pub. Date: Nov. 20, 2014

(54) NON-COMBUSTION PNEUMATIC-VACUUM ENGINE

(71) Applicants: NANJI QIN, San Francisco, CA (US); LINA ZHOU, San Francisco, CA (US); Herguan University Inc., Sunnyvale, CA (US)

(72) Inventors: NANJI QIN, San Francisco, CA (US); Lina Zhou, San Francisco, CA (US)

(73) Assignee: HERGUAN UNIVERSITY INC., SUNNYVALE, US (US)

(21) Appl. No.: 14/280,598

(22) Filed: May 17, 2014

Related U.S. Application Data
(60) Provisional application No. 61/824,998, filed on May 18, 2013.

(51) Int. Cl. F15B 15/02

(52) U.S. Cl. CPC F15B 15/02
USPC 91/418

(57) ABSTRACT

An engine includes cylinders using pressure differences to motivate the pistons. Each cylinder has a first outlet in its' first end, the first outlet being coupled to a vacuum chamber via a first valve and a first conduit, a second outlet in the cylinder's first end, the second outlet being coupled to an air pressure chamber via a second valve and a second conduit, a third outlet in the cylinder's second end, the third outlet being coupled to the vacuum chamber via a third valve and a third conduit, and a fourth outlet in the cylinder's second end, the fourth outlet being coupled to the air pressure chamber via a fourth valve and a fourth conduit. The valves are electrically controlled by a processor. When the first and fourth valves are turned on, the piston is pulled forward by a pressure difference created by the vacuum chamber and is at the same time pushed forward by a pressure difference created by the air pressure chamber. When the piston reaches its maximum length, the first and fourth valves are turned off, and the second and third valves are turned on, and the piston is pulled backward by a pressure difference created by the vacuum chamber and is at the same time pushed backward by a pressure difference created by the air pressure chamber. When the piston reaches its minimum length, the second and third valves are turned off, and the first and fourth valves are turned on.

### REFERENCE TO RELATED APPLICATIONS

The present application claims priority to the provisional Appl. Ser. No. 61/824,998 filed on May 18, 2013, the entire content of which is hereby incorporated by reference.

### TECHNICAL FIELD OF THE INVENTION

The present invention generally relates to non-combustion engine. More particularly, this invention is related to a non-combustion engine with a pull and push dynamic vacuum activation mechanism.

### BACKGROUND OF THE INVENTION

An engine is a machine designed to convert energy into useful mechanical motion. Heat engines, including internal combustion engines and external combustion engines, such as steam engines, burn a fuel to create heat, which then generates mechanical motion. Electric motors convert electrical energy into mechanical motion and pneumatic motors use compressed air and others.

Pneumatic motor converts potential energy in the form of compressed air into mechanical work. They generally convert the compressed air to mechanical work through either linear or rotary motion. Linear motion can come from either a diaphragm or piston actuator, while rotary motion is supplied by either a vane type air motor or piston air motor. Pneumatic motors have existed in many forms over the past two centuries. Some types rely on pistons and cylinders but others use turbines. Many compressed air engines improve their performance by heating the incoming air or the engine itself.

Pistons are most commonly used to achieve linear motion from compressed air. The compressed air is fed into an air-tight chamber that houses the shaft of the piston. Also inside this chamber a spring is coiled around the shaft of the piston in order to hold the chamber completely open when air is not being pumped into the chamber. As air is fed into the chamber the force on the piston shaft begins to overcome the force being exerted on the spring. As more air is fed into the chamber, the pressure increases, and the piston begins to move down the chamber. When it reaches its maximum length the air pressure is released from the chamber and the spring completes the cycle by closing off the chamber to return to its original position.

Another type of pneumatic motor, which is known as a rotary vane motor, uses air to produce rotational motion to a shaft. The rotating element is a slotted rotor which is mounted on a drive shaft. Each slot of the rotor is fitted with a freely sliding rectangular vane. The vanes are extended to the housing walls using springs, cam action, or air pressure, depending on the motor design. Air is pumped through the motor input which pushes on the vanes creating the rotational motion of the central shaft. Rotation speeds vary between 100 and 25,000 rpm depending on several factors which include the amount of air pressure at the motor inlet and the diameter of the housing.

The overall energy efficiency of pneumatic motor is low. The purpose of this invention is to provide a new generation high-efficiency non-combustion engine with a pull and push dynamic vacuum activation mechanism.

The present invention has been made by the inventors in a cooperative research project funded by Herguan University and University of Eastern And Western Medicine. The pull and push dynamic activation mechanism is based on Mr. Nanji Qin's faith and theory that hidden substance or dark matter, which is not comprised of any chemical element listed in the atomic table, carries with space-condensing dark energy. When the revealed substance in an enclosed space is removed, the space will be filled with hidden substance or dark matter. The space-condensing dark energy carried by dark quantum elements can be converted into power through a mechanical assembly. Mr. Nanji Qin's theory was elaborated in cooperation with and under instruction of Professor Yingqiu Wang who has devoted himself for more than three decades in studying and establishing his Herguan Theory. Professor Wang's team, including Mr. Nanji Qin and Mr. Jerry Wang, has made a series of inventions by applying the general principles of Herguan Theory to various application areas.

### SUMMARY OF THE INVENTION

A non-combustion engine with a pull and push dynamic vacuum activation mechanism according to the present invention includes one or more cylinders mechanically coupled with a single crankshaft which transforms reciprocating linear motion into rotation. Each of the cylinders houses one piston. In one end of the cylinder, there exist a first outlet and a second outlet. The first outlet is coupled to a vacuum chamber via a first conduit and a first valve, and the second outlet coupled to a compressed air chamber, herein after referred to as pressure chamber, via a second conduit and a second valve. In the opposite end of the cylinder, there exist a third outlet and a fourth outlet. The third outlet is coupled to the vacuum chamber via a third conduit and a third valve, and the second outlet coupled to the pressure chamber via a fourth conduit and fourth valve. The pressure in the vacuum chamber and the pressure in the pressure chamber are maintained by a dual functional compressor. The compressor is turned on whenever the pressure in the vacuum chamber or in the pressure chamber is lower than a predetermined value.

The initial status of the engine requires that the pressure in the vacuum chamber is maintained at a first predetermined value, and the pressure in the pressure chamber is also maintained at a second predetermined value. To start engine's work, an electronic controller turns on the first valve and the fourth valve at the same time. Via the first conduit, the vacuum chamber sucks the piston forward, and via the fourth conduit, the compressed air pushes the piston forward at the same time. As soon as the piston reaches the first end of the cylinder, i.e. the piston's maximum length, the first and the fourth valves are turned off, but the second and the third valves are turned on. Via the third conduit, the vacuum chamber sucks the piston backward, and via the second conduit, the compressed air pushes the piston backward at the same time. As soon as the piston reaches the second end of the cylinder, i.e. the piston's minimum length, the second and the third valves are turned off, but the first and the fourth valves are turned on. The valves are controlled by a processor. The crankshaft coupled to the pistons transforms the linear reciprocating motions into rotation.

### BRIEF DESCRIPTION OF THE DRAWINGS

FIG. 1 is a schematic diagram illustrating a non-combustion engine comprising a vacuum chamber, a compressor, and a pressure chamber that exerts mechanical work on dual piston cylinders to generate mechanical power which in turn generate electric power.

FIG. 2 is a schematic diagram illustrating a cylinder wherein a piston's reciprocating motion is activated by high-pressured air and vacuum concurrently.

FIG. 3 is a schematic diagram illustrating a vacuum chamber with one conduit coupled to the compressor, and at least two conduits coupled to the piston.

FIG. 4 is a schematic diagram illustrating a compressor with one conduit coupled to the pressure chamber.

FIG. 5 is a schematic diagram illustrating a pressure chamber with one conduit coupled to the compressor, and at least two conduits coupled to the piston.

FIG. 6 is a schematic diagram illustrating a specific application of the present invention wherein a two-way generator is placed inside of an enclosed channel wherein the fluid, other media, in both chambers passes through and activates the generator to transform the moving energy of the fluid into electrical energy.

### DETAILED DESCRIPTION OF THE INVENTION

While the present invention may be embodied in many different forms, designs or configurations, for the purpose of promoting an understanding of the principles of the invention, references will be made to the embodiments illustrated in the drawings and specific language will be used to describe the same. It will nevertheless be understood that no limitation or restriction of the scope of the invention is thereby intended. Any alterations and further implementations of the principles of the invention as described herein are contemplated as would normally occur to one skilled in the art to which the invention relates. In the following description, the use of “a”, “an”, or “the” can refer to the plural. All examples given are for clarification only, and are not intended to limit the scope of the invention.

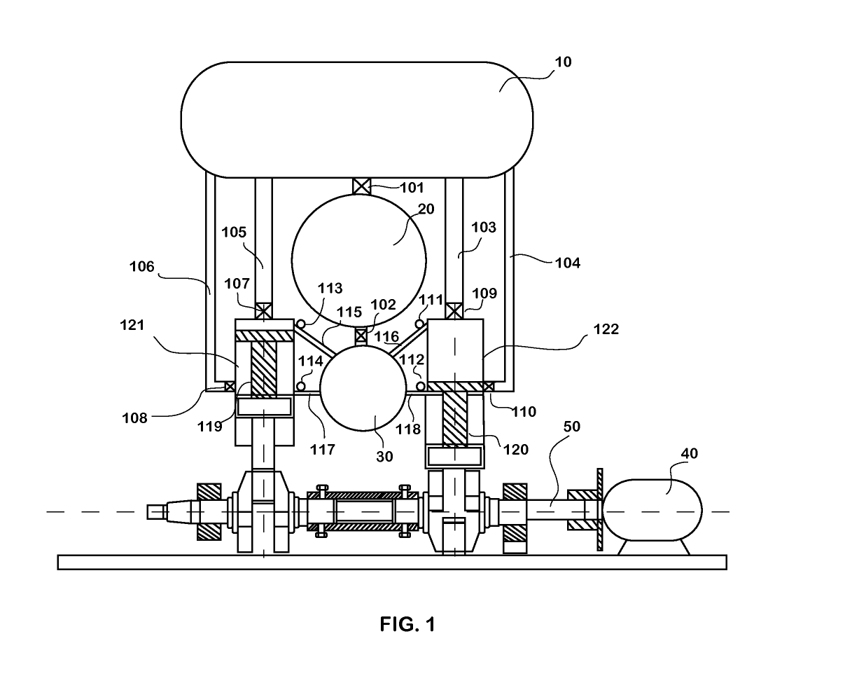

Referring to FIG. 1, which illustrates an engine with a pull and push dynamic activation mechanism according to the preferred embodiment of the invention. The engine includes a compressor 20 with dual functions, a vacuum chamber 10 wherein the vacuum is created and maintained by the compressor 20, a pressure chamber 30 wherein the gaseous pressure is created and maintained by the compressor 20, two symmetrical cylinders 121 and 122 which are mechanically coupled to the vacuum chamber 10 and the pressure chamber 30 via conduits, such as 105-106 and 103-104, and dynamically coupled to a crankshaft 50 via the piston rods of the pistons 119 and 120. The crankshaft 50 powers the generator 40 which transforms mechanical energy into electrical energy. The crankshaft translates reciprocating linear piston motion into rotation. It typically connects to a flywheel to reduce the pulsation characteristic of the stroke cycle.

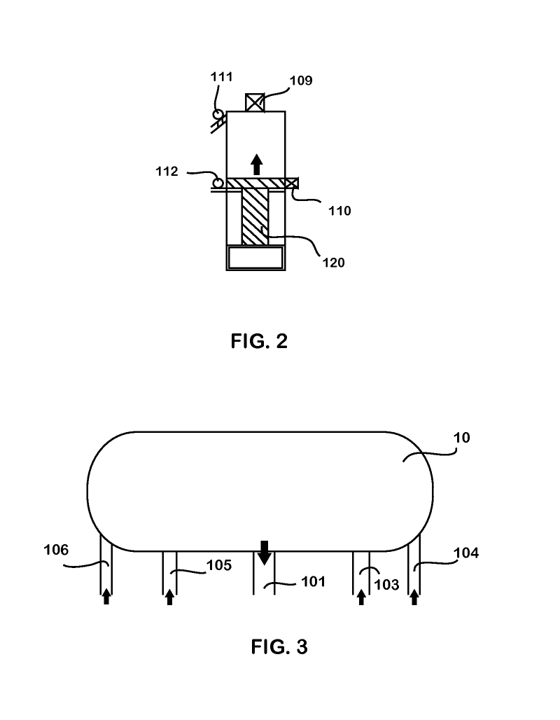

Refers to FIG. 2, which is a schematic diagram illustrating a cylinder wherein a piston's reciprocating motion is activated by high-pressured air and vacuum concurrently. The internal space of the cylinder house is separated into two air-tight chambers by the pistol. There are two outlets in the upper portion of the cylinder. The first outlet is connected to the vacuum chamber 10 via a conduit 103 in FIG. 1, and is controlled by a first valve 109. The second outlet is connected to the pressure chamber 30 via a conduit 116 in FIG. 1, and is controlled by a second valve 111. There are two outlets in the lower portion of the cylinder. The third outlet is connected to the vacuum chamber 10 via a conduit 104 in FIG. 1, and is controlled by a third valve 110. The fourth outlet is connected to the pressure chamber 30 via a conduit 118 in FIG. 1, and is controlled by a fourth valve 112. When the valves 109 and 112 are opened concurrently, the piston 120 is sucked upward by the sucking force provided by the vacuum chamber 10, and concurrently pushed upward by the pressing force provided by the pressure chamber 30. When the valves 110 and 111 are opened concurrently, the piston 120 is sucked downward by the sucking force provided by the vacuum chamber 10, and concurrently pushed downward by the pressing force provided by the pressure chamber 30.

When the piston reaches its lowest position, i.e. the piston's minimum length, the valves 109 and 112 are opened concurrently; and when the piston reaches its highest position, i.e. the piston's maximum length, the valves 110 and 111 are opened concurrently. As such, reciprocating linear piston motion is created. The linear piston motion is then transformed into rotation by the crankshaft 50, which then powers the generator 40.

The cylinders can be in a horizontal position, a vertical position or an inclined position. For gravity consideration, a horizontal position is more preferred than a vertical position in some circumstances.

Now refers to FIG. 3, which is a schematic diagram illustrating the vacuum chamber 10 in FIG. 1. The chamber 10 is coupled to the compressor 20 via a one way valve 101. The chamber 10 is also coupled to the cylinder 122 via conduits 103 and 104, and to the cylinder 121 via the conduits 105 and 106. Vacuum is space that is empty of matter. According to Mr. Nanji Qin's theory, hidden substance or dark matter, which is not comprised of any chemical element listed in the atomic table, carries with hidden space-condensing energy, or dark energy. When the revealed substance or matter in an enclosed space is removed or evacuated, the space will be filled with hidden substance or dark matter. The hidden space-condensing energy can be converted into power through the engine described herein. An approximation to the vacuum is a region with a gaseous pressure much less than atmospheric pressure. A perfect vacuum refers the condition resulted from an ideal test. Yet partial vacuum refers to an actual imperfect vacuum as one might have in a laboratory or in space. The quality of a partial vacuum refers to how closely it approaches a perfect vacuum. Assuming other conditions equal, lower gas pressure means higher-quality vacuum. Ultra-high vacuum chambers operate below one trillionth (10⁻¹²) of atmospheric pressure (100 nPa), and can reach around 100 particles/cm³. Outer space is an even higher-quality vacuum, with the equivalent of just a few hydrogen atoms per cubic meter on average. However, even if every single atom and particle could be removed from a volume, it would still not be empty due to vacuum fluctuations, dark energy, and other phenomena in quantum physics. In modern particle physics, the vacuum state is considered as the ground state of matter. Vacuum is primarily measured by its absolute pressure, but a complete characterization requires further parameters, such as temperature and chemical composition. In the context of the present invention, the higher the quality of vacuum is created in the chamber, the more power that the engine may output.

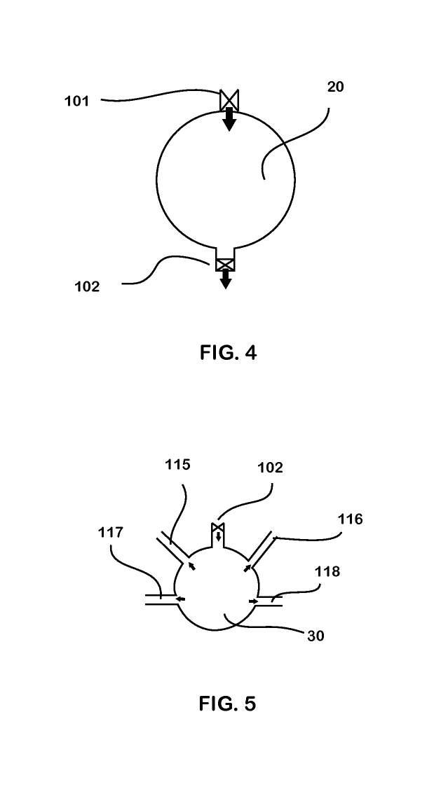

Now refer to FIG. 4, which is a schematic diagram illustrating the compressor 20 in FIG. 1. The compressor 20 is coupled to the vacuum chamber 10 via the one-way valve 101 and to the pressure chamber 30 via the one-way valve 102. When the pressure in the pressure chamber 30 is lower than a predetermined value, the compressor 20 is activated to maintain the pressure in the chamber 30. The vacuum chamber 10 and the pressure chamber 30 are designed in such a coordinated manner that they require maintenance by the compressor 20 at the same time. In other words, both chambers are maintained together. Alternatively, the vacuum chamber 10 and the pressure chamber 30 can be maintained separately. Whenever the pressure in a chamber is lower than a predetermined value, the compressor 20 is activated.

Now refer to FIG. 5, which is a schematic diagram illustrating the pressure chamber 30 in FIG. 1. The pressure chamber 30 is coupled to the compressor 20 via a one-way valve 102. The chamber 30 is also coupled to the cylinder 122 via conduits 116 and 118, and to the cylinder 121 via the conduits 115 and 117. The power generation mechanism by pressured air is just the opposite of the power generation mechanism by vacuum. This invention combines both mechanisms harmoniously into one system, such that pull and push forces are acting on the pistons concurrently.

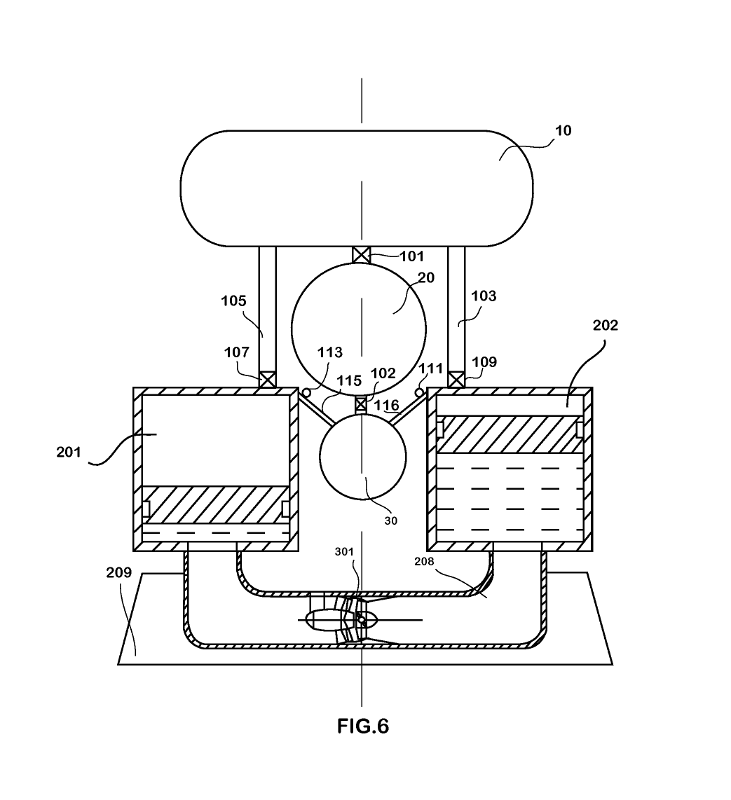

The piston-cylinder structure used in the embodiment according FIGS. 1-5 can be replaced with a pair of chambers which are coupled together through a hydraulic channel. The chambers 201 and 202 are filled with hydraulic fluid. FIG. 6 is a schematic diagram illustrating a specific application of the present invention wherein a two-way generator 301 is placed inside of an enclosed channel 208 wherein the hydraulic fluid in both chambers 201 and 202 passes through and activates the generator to transform the moving energy of the fluid into electrical energy.

The working principle of the embodiment according to FIG. 6 is the same as that of the embodiment according FIGS. 1-5. In further application, the system can be used for generating electricity by using the cohesive force created by a vacuum and the natural repulsive force of deep water, such as ocean. The cohesive force may trigger the repulsive force of deep water that in turn drives water up. The flowing force may activate a hydroelectric generator.

While one or more embodiments of the present invention have been illustrated in detail, the skilled artisan will appreciate that modifications and adoptions to those embodiments may be made without departing from the scope and spirit of the present invention as set forth in the following claims.

1. An engine using air pressure and vacuum, comprising:
a dual-function compressor coupled to a vacuum chamber and an air pressure chamber, said compressor maintaining said chambers to predetermined pressure values;
one or more cylinders, each of which housing a piston coupled to a single crankshaft which transforms reciprocating linear motion into rotation;
wherein each of said cylinder has a first outlet in its first end, said first outlet being coupled to said vacuum chamber via a valve and a first conduit;
wherein each of said cylinder comprises:
a first outlet in said cylinder's first end, said first outlet being coupled to said vacuum chamber via a first valve and a first conduit,
a second outlet in said cylinder's first end, said second outlet being coupled to said air pressure chamber via a second valve and a second conduit;
a third outlet in said cylinder's second end, said third outlet being coupled to said vacuum chamber via a third valve and a third conduit,
a fourth outlet in said cylinder's second end, said fourth outlet being coupled to said air pressure chamber via a fourth valve and a fourth conduit;
wherein said valves are electrically controlled by a processor, and
wherein when said first and fourth valves are turned on, said piston is pulled forward by a pressure difference created by said vacuum chamber and is at the same time pushed forward by a pressure difference created by said air pressure chamber;
wherein when said piston reaches its maximum length, said first and fourth valves are turned off, and said second and third valves are turned on, and said piston is pulled backward by a pressure difference created by said vacuum chamber and is at the same time pushed backward by a pressure difference created by said air pressure chamber; and
wherein when said piston reaches its minimum length, said second and third valves are turned off, and said first and fourth valves are turned on.

2. The engine of claim 1, wherein said first valve and said third valve are identical.

3. The engine of claim 1, wherein said second valve and said fourth valve are identical.

4. The engine of claim 1, wherein said cylinder is horizontally placed.

5. The engine of claim 1, wherein said cylinder is vertically placed.

6. The engine of claim 1, wherein said cylinder is placed in an inclined position.

7. The engine of claim 1, wherein said crankshaft is coupled to an electrical generator.

8. The engine of claim 7, wherein partial electricity used by said compressor to maintain said vacuum chamber and said air pressure chamber is from said generator.

9. The engine of claim 1, wherein the number of cylinders is two.

10. The engine of claim 1, wherein the number of cylinders is four.

11. The engine of claim 1, wherein the number of cylinders is six.

12. The engine of claim 1, wherein the number of cylinders is eight.
